(19) United States
(12) Patent Application Publication
(10) Pub. No.: US 2004/0172329 A1
(43) Pub. Date: Sep. 2, 2004

(54) Method of and apparatus for point management, computer product for point management

(75) Inventor: Mitsuo Nishizawa, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/758,036

(22) Filed: Jan. 16, 2004

(30) Foreign Application Priority Data
Feb. 28, 2003 (JP) 2003-054411

(51) Int. Cl. G06F 17/60

(52) U.S. Cl. 705/14

(57) ABSTRACT

A sum of points of all customers that are invalidated without being used within a predetermined period is calculated as total invalidated points, payback scores are allotted to each customer according to number of days passed since a previous purchasing date to a next purchasing day, points to be distributed to each customer are calculated by multiplying the total invalidated points by a ratio of the payback score allotted to each customer to total payback score of all customers, and the calculated points are distributed to each customer.

### BACKGROUND OF THE INVENTION

1) Field of the Invention

The present invention relates to a point management method for managing a reward point (hereinafter, “point”) allotted for purchase amount of a product, and for invalidating the point that are not used for a predetermined period of time, and more particularly to a point management method that can stimulate customers' purchasing desire and can effectively perform a sales promotion even when the point is invalidated.

2) Description of the Related Art A point system that allots a point that is available for a discount or an exchange of a product according to a purchase amount of products. Dealers utilize the point system, thereby making it possible to stimulate customers' purchasing desire and perform a sales promotion.

Normally, according to this system, an invalidation date is set for the point. Once the point that is not being used is invalidated, the customer can no longer use the point. Therefore, knowing how much points have invalidated is important information to be aware of how effectively the point system is working.

A conventional technology, for example, in Japanese Patent Application Laid-open No. 2000-268094 discloses a point management system that accumulates the point allotted to customers including those which is invalidated at each dealer, and that enables to accurately understand a working status of the point management system.

However, the conventional technology merely offers the information on the working status of the point management system without solving a problem of the sales promotion using the information on the point invalidated.

If the point is invalidated, in particular, each customer cannot use the invalidated point. Therefore, even if each dealer can accurately know the number of the invalidated points, it is difficult to motivate the customers to purchase a product again.

Further, the point is allotted at a sales promotion expense. However, if the points are invalidated without being used, the expense prepared for the sales promotion is wasted, thereby resulting in a poor efficiency of the sales promotion.

### SUMMARY OF THE INVENTION

It is an object of the present invention to solve at least the problems in the conventional technology.

The apparatus for managing a point allotted to each customer for an amount of a purchasing and for invalidating the point that is not used within a predetermined period, according to one aspect of the present invention includes an invalidated point calculating unit that calculates total invalidated points from a sum of the points invalidated for all customers, and a point payback calculating unit that calculates a point payback to be distributed to each customer from the total invalidated points, and that makes a payback of the point calculated to the each customer.

The method of managing a point allotted to each customer for an amount of a purchasing and for invalidating the point that is not used within a predetermined period, according to another aspect of the present invention includes calculating total invalidated points from a sum of the points invalidated for all customers, calculating a point payback to be distributed to each customer from the total invalidated points, and making a payback of the point calculated to the each customer.

The computer program for managing a point allotted to each customer for an amount of a purchasing and for invalidating the point that is not used within a predetermined period, according to still another aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a point management apparatus according to a first embodiment of the present invention;

FIG. 2 is an example of a point invalidation setting table in a setting management table shown in FIG. 1;

FIG. 3 is an example of a payback score setting table in the setting point management table shown in FIG. 1;

FIG. 4 is an example of a point allotment setting table in the setting management table shown in FIG. 1;

FIG. 5 is an example of a payback date setting table in the setting management table shown in FIG. 1;

FIGS. 6A and 6B are an example of a customer point management table shown in FIG. 1;

FIG. 7 is a flowchart of a point management processing according to the first embodiment;

FIG. 8 is a flowchart of a point update processing processed by a point management unit and a point payback unit shown in FIG. 1;

FIG. 9 is a flowchart of a total invalidated point calculation processing processed by a point invalidation processing unit and a total invalidated point calculation unit shown in FIG. 1;

FIG. 10 is a flowchart of a point payback processing processed by a point payback unit shown in FIG. 1;

FIG. 11 is a flowchart of a point information output processing processed by a point information output unit shown in FIG. 1;

FIG. 12 depicts an example of a data structure of a total invalidated point data shown in FIG. 1;

FIG. 13 is a schematic diagram of a computer system according to a second embodiment of the present invention;

FIG. 14 is a block diagram of a main unit of the computer system shown in FIG. 13; and

FIGS. 15A and 15B depict an example of managing points with a purchasing basis in the customer point management table shown in FIG. 6.

### DETAILED DESCRIPTION

Exemplary embodiments of a method of, an apparatus for, and a computer product for point management according to the present invention are explained below in detail, with reference to the accompanying drawings.

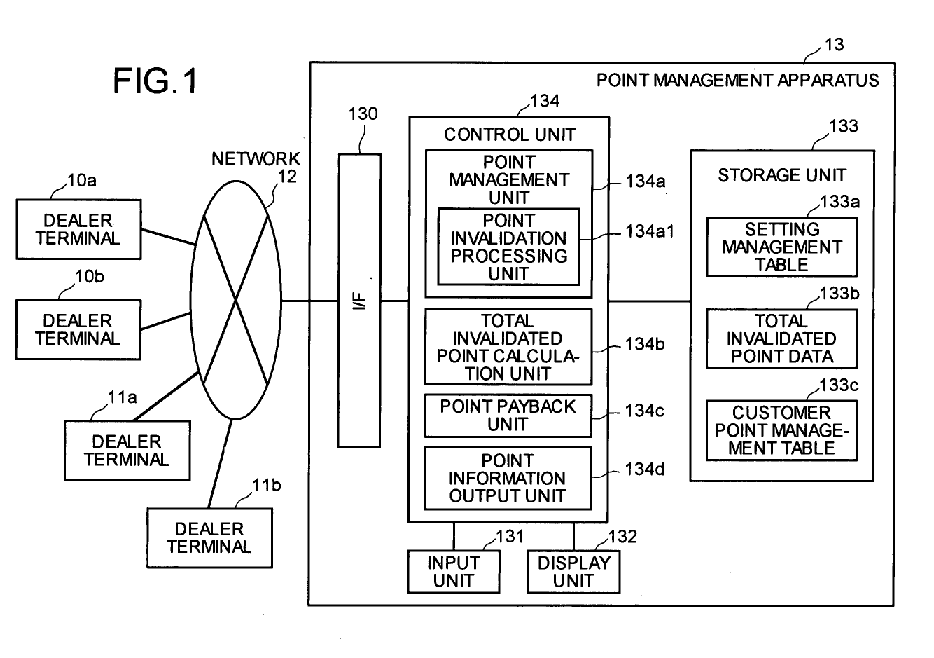

FIG. 1 is a block diagram of a point management apparatus according to a first embodiment of the present invention. The point management apparatus 13 is constituted to be connected, through a network 12, to dealer terminals 10a and 10b of dealers which sell products and customer terminals 11a and 11b of customers each of whom receives point services.

Each of the dealer terminals 10a and 10b is a terminal that performs processings including reading a point card which each customer owns, acquiring information such as a user ID of the customer, and transmitting the information together with a purchase amount of the customer to the point management apparatus 13.

Each of the customer terminals 11a and 11b is a terminal accessible to the point management apparatus 13 through the network 12 such as the Internet. Each customer operates the customer terminal 11a or 11b and can inquire the point management apparatus 13 of points allotted to the customer.

The point management apparatus 13 is a management apparatus which manages points allotted to each customer, calculates total invalidated points by accumulating points of all customers which are invalidated without being used within a predetermined period, and distributes and makes payback the total invalidated points to the respective customers. The point management apparatus 13 also receives inquiries about points from the customer terminals 11a and 11b and transmits relevant information in response to the inquiries.

The point management apparatus 13 includes an interface unit 130, an input unit 131, a display unit 132, a storage unit 133, and a control unit 134. The interface unit 130 is a network interface that exchanges data with the dealer terminals 10a and 10b and the customer terminals 11a and 11b through the network 12.

The input unit 131 is an input device such as a keyboard or a mouse. The display unit 132 is a display device such as a display or a liquid crystal panel. The storage unit 133 is a storage device such as a hard disk. This storage unit 133 stores a setting management table 133a, total invalidated point data 133b, and a customer point management table 133c.

The setting management table 133a is a management table that set various conditions on the invalidation and payback of points.

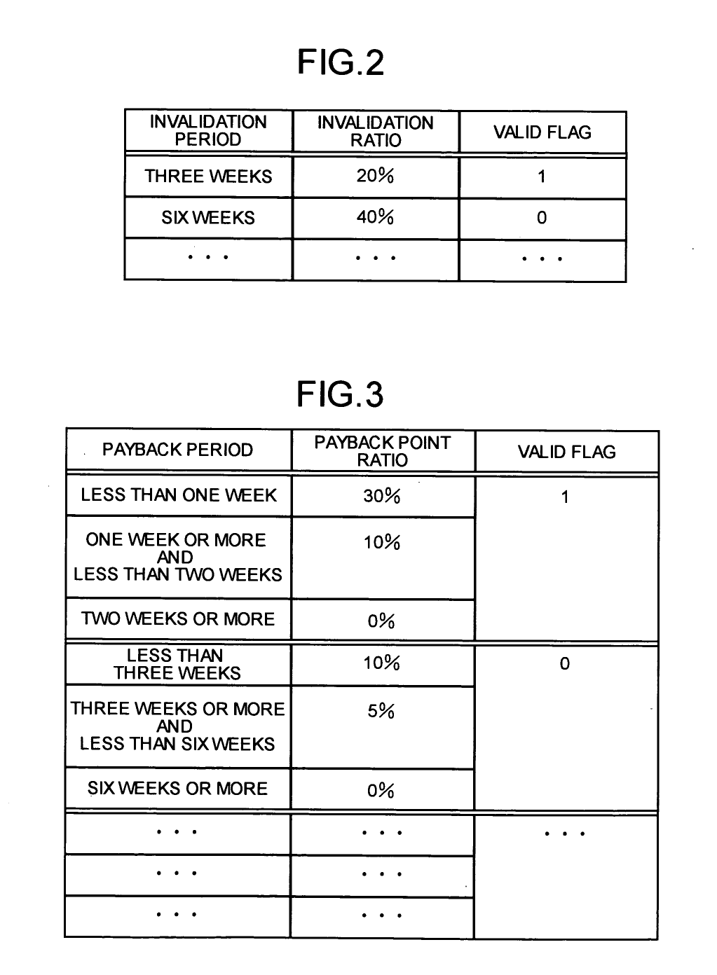

FIG. 2 is an example of a point invalidation setting table in a setting management table shown in FIG. 1. The point invalidation setting table sets a ratio of invalidating points of each customer if a predetermined period passes since the latest purchasing date when the customer purchases a product.

The point invalidation setting table includes items of an invalidation period, an invalidation ratio, and a valid flag. The invalidation period is a period since the latest purchasing date until a date of invalidation of points. The invalidation ratio is set at a rate at which the points allotted to the customer are invalidated if the invalidation period passes.

The valid flag indicates a currently valid setting among some settings. If the valid flag is “1”, it indicates that the setting is valid. If “0”, it indicates that the setting is now invalid. The example shown in FIG. 2 depicts that the setting that 20% of points allotted to a customer are invalidated if three weeks pass since the latest purchasing date of the customer:

FIG. 3 is an example of a payback score setting table in the setting point management table shown in FIG. 1. The payback scores are scores used to determine a distribution ratio if total invalidated points calculated by accumulating invalidated points of all customer are distributed and paid back to the respective customers. The more payback scores are, the higher distribution ratio of the customer is, and the more payback points are.

The payback score setting table sets a ratio of payback scores allotted to each customer to a purchase amount of the customer if the customer purchases a product within the predetermined period of time since the latest purchasing date when the customer purchases a product.

This payback score setting table includes items of a payback period, a payback score ratio, and a valid flag. The payback period is a period since the latest purchasing date until the customer does another purchasing. The payback score ratio is a ratio set so as to calculate payback scores by which the purchase amount is multiplied if the user does a purchasing within the payback period.

The valid flag indicates a currently valid setting among some settings. In the currently valid setting in the example of FIG. 3, 30% of the purchase amount of a product is allotted to the customer as the payback scores if the customer does a purchasing less than one week after the latest purchasing date. 10% of the purchase amount is allotted to the customer as the payback scores if the customer does a purchasing one week or more and less than two weeks after the latest purchasing date. In addition, if two weeks or more pass since the latest purchasing date, no payback scores (0% of the purchase amount) are allotted to the customer even if the customer does a purchasing after the date.

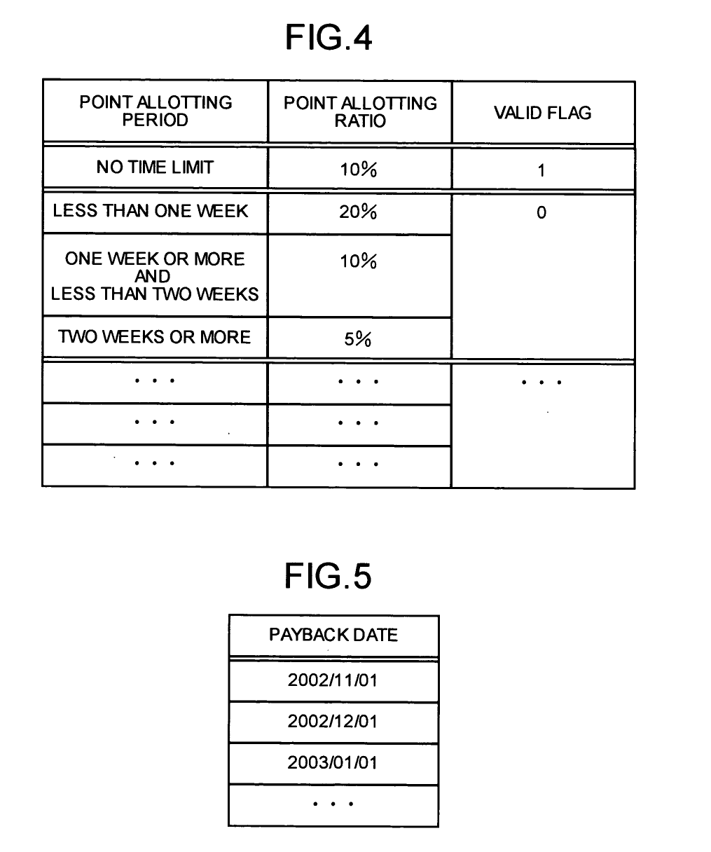

FIG. 4 is an example of a point allotment setting table in the setting management table shown in FIG. 1. The point allotment setting table sets a ratio of points allotted to the customer to the purchase amount of the customer if the customer purchases a product within the predetermined period since the latest purchasing date when the customer purchases a product.

The point allotment setting table includes items of a point allotting period, a point allotting ratio, and a valid flag. The point allotting period is a period since the latest purchasing date until the customer does another purchasing. The point allotting ratio is a ratio set to calculate points by multiplying the purchase amount by the ratio if the customer does a purchasing within the point allotting period.

The valid flag indicates a currently valid flag among some settings. In the example of FIG. 4, the setting that 10% of the purchase amount is allotted to the customer as points without time limit since the latest purchasing date is valid. The setting can be made so that the point allotting ratio is changed according to the point allotting period. The customer can use the allotted points with one point corresponding to, for example, one yen when the customer purchases a product.

FIG. 5 is an example of a payback date setting table in the setting management table shown in FIG. 1. The payback date setting table sets a date when a payback processing is performed. In the example of FIG. 5, the payback date is set so that the payback processing is performed on the first day of every month and that points are paid back to each customer at the end of the month.

Referring back to FIG. 1, the total invalidated point data 133b is data stored as total invalidated points calculated by accumulating points that are invalidated within a period defined by the payback date among the points allotted to the customer. In addition, as the total invalidated point data 133b, data such as total invalidated points for each previous period and a ratio of two consecutive periods in terms of the total invalidated points (which is a ratio of a certain month to a previous month if the period defined by the payback date is a month-basis period) can be stored.

The customer point management table 133c is a management table which records a purchasing result of each customer including the points allotted to the customer, the payback scores, and the latest purchasing date. The structure of the customer point management table 133c will next be explained in detail.

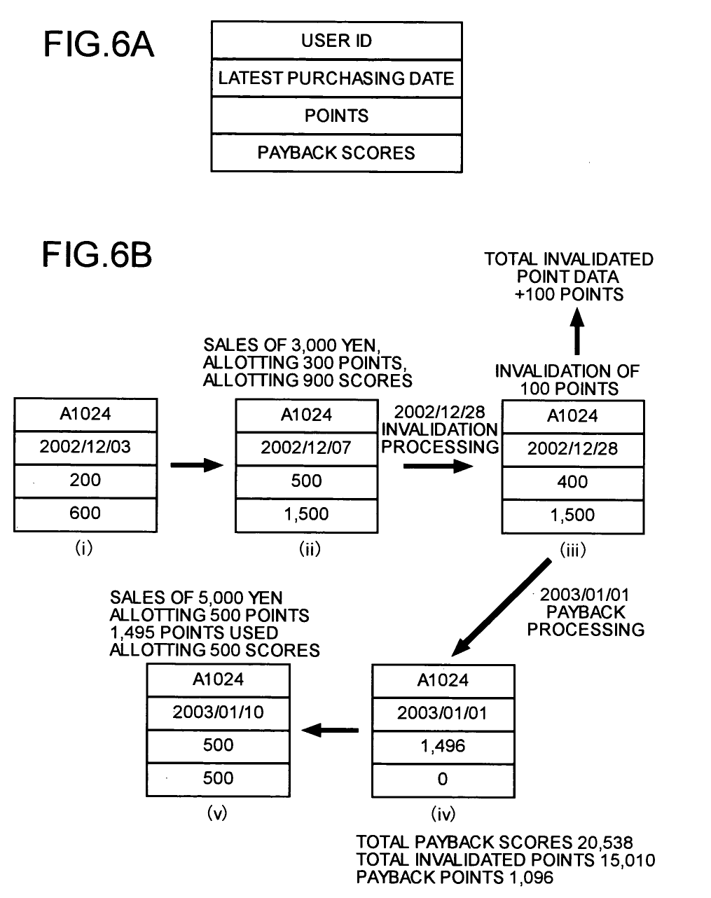

FIGS. 6A and 6b are an example of the customer point management table 133c shown in FIG. 1. The data structure for one customer in the customer point management table 133c is shown. The customer point management table 133c includes items of a user ID, a latest purchasing date, points, and payback scores.

The user ID is an identification symbol allotted to each customer. The latest purchasing date is a date of the latest purchasing date among past purchasing dates. The points and payback scores are allotted to the customer corresponding to the user ID.

How this customer management table 133c is updated by a point allotting processing, a point invalidation processing, and a point payback processing will be explained. As shown in (i) of FIG. 6B, it is assumed that the latest purchasing date of the customer having a user ID of A1024 is Dec. 3, 2002 and that this customer earns 200 points and 600 payback scores.

As shown in (ii) of FIG. 6B, if the customer purchases a product at 3,000 yen on Dec. 7, 2002, points corresponding to 10% of the purchase amount are allotted to the customer and the points of the customer increase by 300 points from 200 to 500 points (¥3,000×0.1=300 points) according to the setting of the point allotment setting table shown in FIG. 4.

Further, since a period which has passed since the latest purchasing date of Dec. 3, 2002 is less than one week, payback scores corresponding to 30% of the purchase amount are allotted to the customer and the payback scores increase by 900 scores from 600 to 1500 (¥3,000×0.3=900 scores) according to the setting of the payback score setting table shown in FIG. 3. In addition, the latest purchasing date is rewritten to Dec. 7, 2002.

Thereafter, if this customer does no purchasing until Dec. 28, 2002, this means that three weeks have passed since the latest purchasing date of Dec. 7, 2002. According to the setting of the point invalidation setting table shown in FIG. 2, the invalidation processing for invalidating 20% of the points is performed.

As shown in (iii) of FIG. 6B, 20% of the points, i.e., 100 points are invalidated (500 points×0.2=100 points) and the points of the customer decrease from 500 to 400 points and the invalidated 100 points are added to the total invalidated points stored in the total invalidated point data 133b. In addition, the latest purchasing date is rewritten to the date when the invalidation processing is performed, i.e., Dec. 28, 2002.

If the customer holds no purchasing until Jan. 1, 2003, the point payback processing is performed according to the setting of the payback date setting table shown in FIG. 5. In this payback processing, total payback scores are calculated by accumulating the payback scores of all customers and points are paid back to each customer according to a ratio of the payback scores of the customer to the total payback scores.

Specifically, if the total payback scores of all customers in December of 2002 are 20,538 and the total invalidated points in the same month are 15,010, then the payback scores of the customer are 1,500 and the points paid back to this customer are, therefore, calculated as:

15,010×1,500/20,538=1,096 (decimal numbers are rounded down).

A state of the customer point management table 133c after the point payback processing is over shown in (iv) of FIG. 6. If the point payback processing is over, a date when the payback processing is performed is set as the latest purchasing date. The points amount to 1,496 points by adding the paid back 1,096 points to the original 400 points. If the point payback processing is over, the payback scores in December of 2002 are initialized and set at zero.

It is assumed that this customer purchases a product at 5,000 yen on Jan. 10, 2003. At that time, if the customer uses all of the 1,496 points, the customer can purchase the product(s) at 3,504 yen with one point converted to one yen.

If so, as shown in (v) of FIG. 6B, points corresponding to 10% of the purchase amount, i.e., 500 points (¥5,000×0.1=500 points) are newly allotted to the customer according to the setting of the point allotment setting table shown in FIG. 4. In addition, since the period which passes since the latest purchasing date is equal to or more than one week and less than two weeks, the payback scores corresponding to 10% of the purchase amount, i.e., 500 payback scores (¥5,000×0.1=500 scores) are allotted to the customer according to the setting of the payback score setting table shown in FIG. 3.

Referring back to FIG. 1, the control unit 134 controls the entirety of the point management apparatus 13. The control unit 134 includes a point management unit 134a, a total invalidated point calculation unit 134b, a point payback unit 134c, and a point information output unit 134d.

The point management unit 134a is a management unit that allots points to each customer and makes the points invalidated when the predetermined period is passed without being used. Specifically, the point management unit 134a receives a customer point update request together with the user ID and the purchase amount from each of the dealer terminals 10a and 10b of the dealer when the customer purchases a product, and updates the points and latest purchasing date of the corresponding customer in the customer point management table 133c.

The point management unit 134b includes appoint invalidation processing unit 134a1 which performs a point invalidation processing. Specifically, while referring to the point invalidation setting table shown in FIG. 2, the point invalidation processing unit 134a1 invalidates the points of each customer at a predetermined ratio according to the period which passes since the latest purchasing date.

The total invalidated point calculation unit 134b is a calculation unit that calculates a sum of points of each customer invalidated by the point invalidation processing unit 134a and that stores the total invalidated points in the total invalidated point data 133b. The total invalidated point calculation unit 134b can also store the total invalidated points for each month, calculate a ratio of a present month to the previous month in terms of the total invalidated points, and store these pieces of information.

The point payback unit 134c is a payback unit that calculates points to be distributed to each customer from the total invalidated points and that makes payback the calculated points to each customer. Specifically, the point payback unit 134c receives a customer payback score update request from the dealer terminals 10a or 10b when the customer purchases a product, calculates the payback scores while referring to the payback score setting table shown in FIG. 3, and updates the payback scores of the corresponding customer in the customer point management table 133c.

On the date set in the payback date setting table shown in FIG. 5, the payback scores of all customers are accumulated to thereby calculate total payback scores, and the ratio of the payback scores of each customer to the total payback scores is multiplied by the total invalidated points to thereby calculate points distributed to each customer. The points thus calculated are added to the points of each customer in the customer point management table 133c to update the points of each customer and the points are paid back to the customer.

The point information output unit 134d is an output unit that receives an inquiry about a state of points from each of the customer terminals 11a and 11b and that outputs information on the inquiry. Specifically, the point information output unit 134d transmits information on the total invalidated points at the time of the inquiry, and predicts points to be paid back to the customer on the next payback date, and transmits the prediction result. Further, the point information output unit 134d outputs information on a change of the total invalidated points in each month stored in the total invalidated point data 133b or information on a ratio of the present month to the previous month in terms of the total invalidated points.

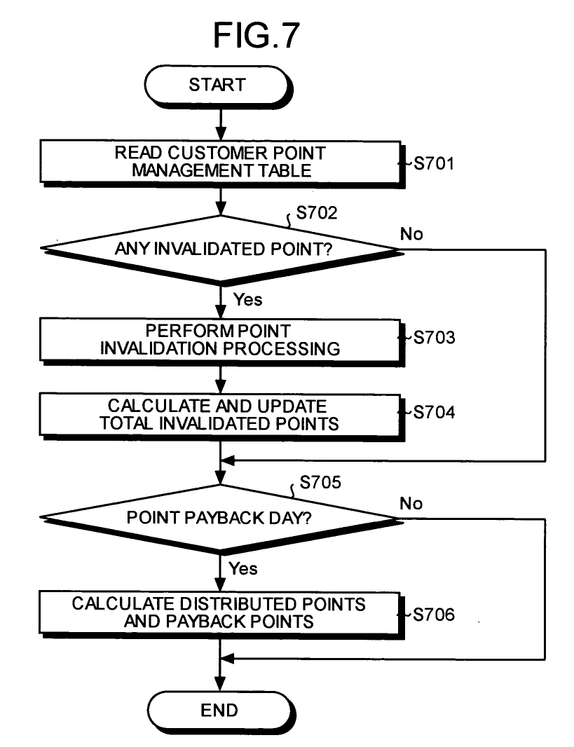

FIG. 7 is a flowchart of a point management processing according to the first embodiment. This processing is performed, for example, everyday at the end of business hours.

The apparatus 13 reads the customer point management table 133c (at a step S701) and determines whether there are invalidated points in the points of each customer (at a step S702).

If there are invalidated points (“Yes” at the step S702), the apparatus 13 decreases the number of points of the customer who owns the invalidated points in the customer point management table 133c by the invalidated points and updates the points of the customer therein (at a step S703). The apparatus 13 then calculates a sum of invalidated points of the customer, adds the calculated sum of invalidated points to the total invalidated points stored in the total invalidated point data 133b, and thereby updates the total invalidated points (at a step S704). If there are no invalidated points (“No” at the step S702), the processing directly goes to a step S705.

The apparatus determines whether the date when the point management processing is performed falls on the point payback date (at the step S705). If the point management processing date falls on the point payback date (“Yes” at the step S705), the apparatus 13 calculates points distributed to each customer from the total invalidated point data, updates the points of each customer in the customer point management table 133c, and makes payback the points to the customer (at a step S706). If the date does not fall on the point payback date (“No” at the step S705), the apparatus 13 finishes the point management processing.

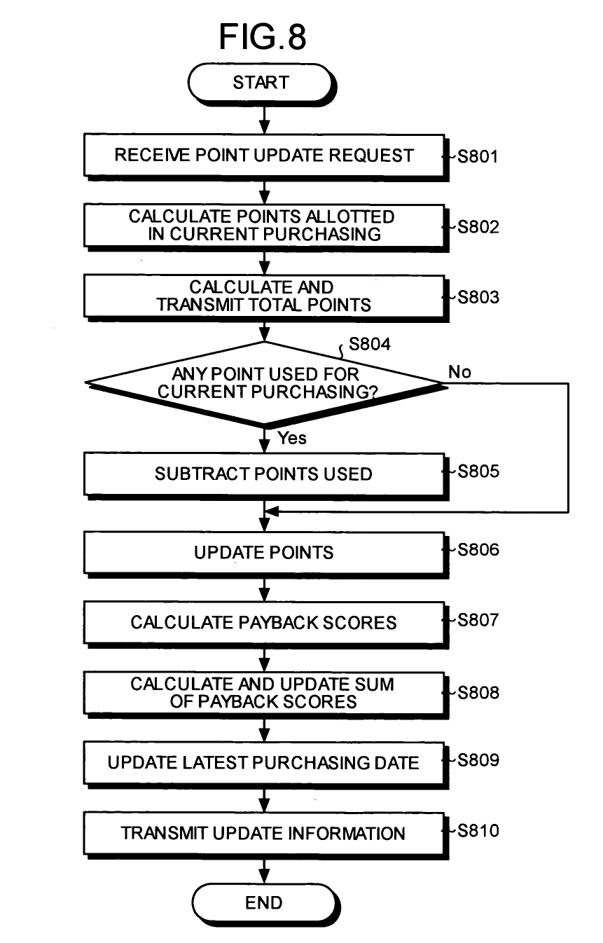

Processing procedures for a point update processing performed by the point management unit 134a and the point payback unit 134c shown in FIG. 1 when a customer purchases a product will be explained. FIG. 8 is a flowchart of the point update processing processed by the point management unit 134a and the point payback unit 134c shown in FIG. 1 when the customer purchases a product.

As shown in FIG. 8, the point management unit 134a receives a point update request of the customer who purchases the product(s) together with the user ID and the purchase amount of the customer from the dealer terminal 10a or 10b of the dealer (at a step S801). The point management unit 134c reads information on the points of the customer, the latest purchasing date, and the payback scores corresponding to the user ID from the customer point management table 133c and calculates points allotted to this customer while referring to the point allotment setting table (at a step S802).

The point management unit 134a calculates a sum of the read points and the calculated points, transmits the total points to the dealer terminal 10a or 10b of the dealer, and notifies the customer of the total points (at a step S803). Thereafter, the point management unit 134a checks whether the customer uses the points in a purchasing of the day (at a step S804). If the customer uses the points (“Yes” at the step S804), the point management unit 134a subtracts the points to be used from the calculated total points (at a step S805). If the user does not use the points (“No” at the step S804), the processing directly goes to a step S806. Using the resultant points, the point management unit 134a updates the points of the corresponding customer in the point allotment setting table (at a step S806).

The point payback unit 134c calculates payback scores allotted to the customer in this purchasing while referring to the payback score setting table (at a step S807), adds the calculated payback scores to the payback scores of the corresponding customer in the customer point management table 133c, calculates total payback scores, and updates data on the payback scores (at a step S808).

The point management unit 134a updates the latest purchasing date of the corresponding customer in the customer point management table 133c to this purchasing date (at a step S809), transmits information on the updated points and the payback scores to the dealer terminal 10a or 10b of the dealer, and notifies the customer of the information (at a step S810).

While it is assumed at the step S804 that the customer can also use the points allotted to the customer in this purchasing, a setting can be made so that, for example, the customer is allowed to use the points allotted in this purchasing from the next and the following purchasing. Further, a setting can be made so as to determine a ratio of the points at which the customer can use the points in this purchasing among the points allotted to the customer in this purchasing and to restrict the points which the customer can use in this purchasing.

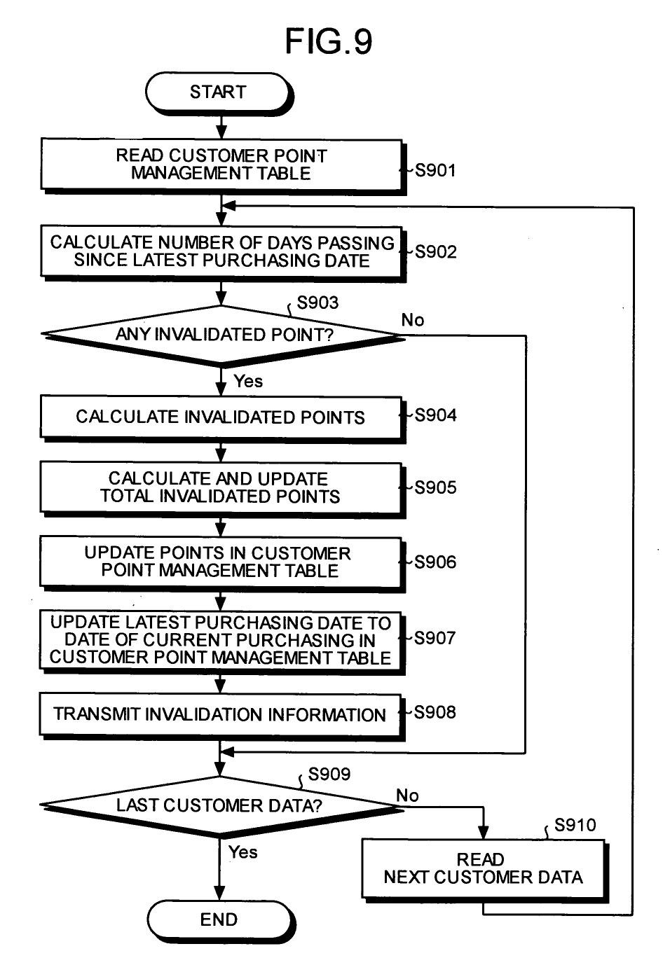

Processing procedures for a total invalidated point calculation processing performed by the point invalidation processing unit 134a1 and the total invalidated point calculation unit 134b shown in FIG. 1 will be explained. FIG. 9 is a flowchart of the total invalidated point calculation processing performed by the point invalidation processing unit 134a1 and the total invalidated point calculation unit 134b shown in FIG. 1. This flowchart illustrates the processings from the steps S701 to S704 shown in FIG. 7 in more detail.

The point invalidation processing unit 134a1 reads the customer point management table 133c (at a step S901) and calculates the number of days that pass since the latest purchasing date stored in the customer point management table 133c (at a step S902). The point invalidation processing unit 134a1 determines whether the number of days that pass is larger than the invalidation period and checks whether there are invalidated points while referring to the invalidation period set in the point invalidation setting table (at a step S903).

If there are no invalidated point (“No” at the step S903), the processing directly goes to a step S909. If there are invalidated points (“Yes” at the step S903), the point invalidation processing unit 134a1 calculates invalidated points using the invalidation ratio set in the point invalidation setting table (at a step S904).

The total invalidated point calculation unit 134b adds the invalidated points thus calculated to the total invalidated points stored in the total invalidated point data 133b and thereby updates the total invalidated point data 133b (at a step S905). The total invalidated point calculation unit 134b subtracts the invalidated points from the points stored in the customer point management table 133c and thereby updates the customer point management table 133c (at a step S906).

Thereafter, the total invalidated point calculation unit 134b updates the latest purchasing date stored in the customer point management table 133c to the date of this purchasing (at a step S907). The total invalidated point calculation unit 134b then transmits a notification that the points are invalidated to the customer terminal 11a or 11b of the customer (at a step S908).

The point invalidation processing unit 134a1 determines whether this customer data is the last customer data in the customer point management table 133c (at a step S909). If the data is the last data (“Yes” at the step S909), the point invalidation processing unit 134a1 finishes this processing. If the data is not the last data (“No” at the step S909), the point invalidation processing unit 134a1 reads the next customer data (at a step S910) and repeats processing procedures from the step S902 and S909.

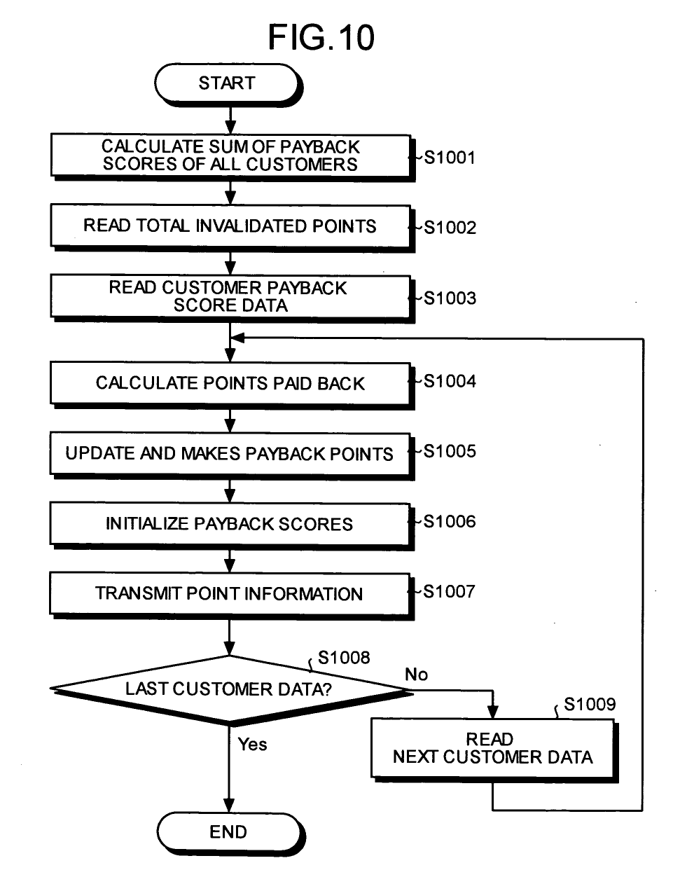

Processing procedures for the point payback processing performed by the point payback unit 134c shown in FIG. 1 will be explained. FIG. 10 is a flowchart of the point payback processing performed by the point payback unit 134c shown in FIG. 1. This flowchart illustrates the processing executed at the step S706 shown in FIG. 7 in more detail. The point payback processing is performed on the day set in the payback date setting table in the setting management table 133a.

The point payback unit 134c calculates a sum of the payback scores of all customers from data on the payback scores of each customer in the customer point management table 133c (at a step S1001). The point payback unit 134c reads the total invalidated point data 133b (at a step S1002) and reads the data on the payback scores of each customer (at a step S1003).

The point payback unit 134c calculates points paid back to the customer by multiplying the total invalidated points by a ratio of the payback scores of the customer to the total payback scores of all customers (at a step S1004). The point payback unit 134c then adds the calculated points to the points of the corresponding customer in the customer point management table 133c, updates the points, and makes payback the points to the customer (at a step S1005).

After the payback of the points is over, the point payback unit 134c initializes the payback scores of the customer to set the payback scores at zero (at a step S1006). Thereafter, the point payback unit 134c transmits the number of payback points to the customer terminal 11a or 11b of the customer to thereby notify the customer of the number of payback points (at a step S1007).

The point payback unit 134c then determines whether this customer data is the last customer data in the customer point management table 133c (at a step S1008). If the data is the last customer data (“Yes” at the step S1008), the point payback unit 134c finishes this processing. If the data is not the last data (“No” at the step S1008), the point payback unit 134c reads the next customer data (at a step S1009) and repeats the processings from the steps S1004 to S1008.

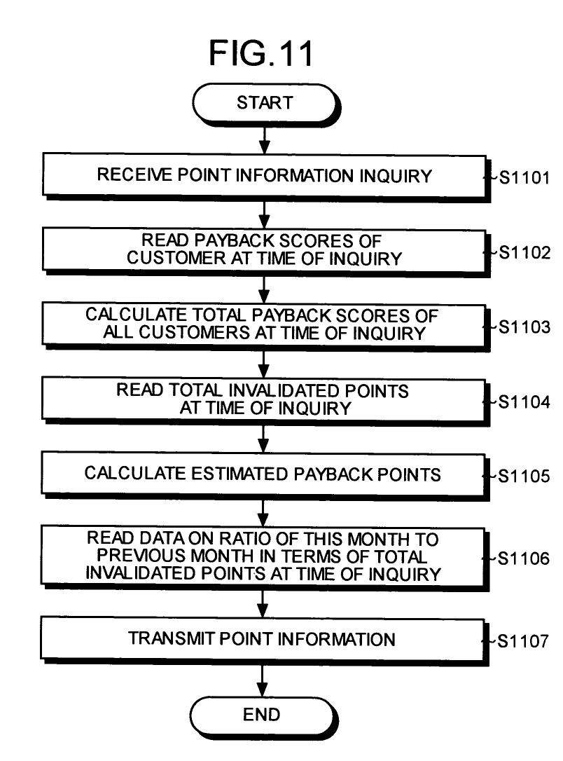

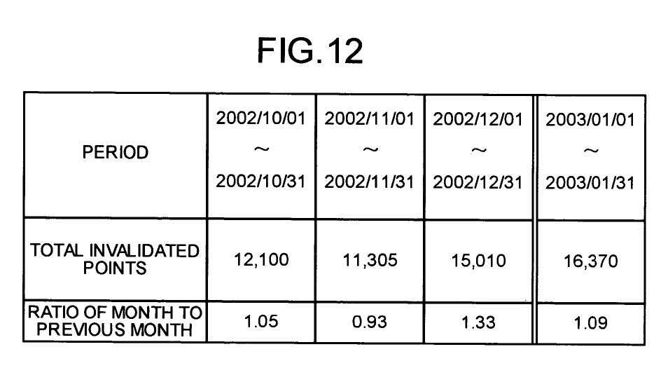

Processing procedures for a point information output processing performed by the point information output unit 134d shown in FIG. 1 will be explained. FIG. 11 is a flowchart which illustrates the processing procedures for the point information output processing performed by the point information output unit 134d shown in FIG. 1. FIG. 12 depicts an example of a data structure of the total invalidated point data 133b shown in FIG. 1. As shown in FIGS. 11 and 12, an instance in which data on the total invalidated points in every previous period and a ratio of the total invalidated points of two consecutive periods for each previous period is also stored in the total invalidated point data 133b will be explained. In FIGS. 11 and 12, since the period is set at one month, the ratio of the two consecutive periods is a ratio of a certain month to a previous month.

The point information output unit 134d receives a point information inquiry from the customer terminal 11a or 11b of the customer (at a step Sl01). The point information output unit 134d reads the payback scores of the customer at the time of receiving the inquiry (at a step S1102), calculates total payback points of all customers at the time of receiving the inquiry (at a step S1103), and further reads the total invalidated points at the time of receiving the inquiry (at a step S1104).

The total invalidated points at the time of receiving the inquiry is 16,370 and the final total invalidated points for periods in January of 2003 are settled on Jan. 31, 2003.

The point information output unit 134d then calculates a ratio of the payback scores of the customer at the time of receiving the inquiry to the total payback scores of all customers at the time of receiving the inquiry and multiplies the total invalidated points at the time of receiving the inquiry by the calculated ratio, thereby calculating points predicted to be paid back to the customer (at a step S1105).

A method for this prediction is not limited to the method explained above but an arbitrary method can be used. For example, the point information output unit 134d may read the total invalidated points for the periods for which the previous point payback processing is performed and multiplies the read total invalidated points by the ratio calculated at the step S1105, thereby calculating points predicted to be paid back to the customer this time. In the example shown in FIG. 12, the total invalidated points for the periods of the previous payback processing are 15,010.

Thereafter, the point information output unit 134d performs a processing for reading the data on the ratio of this month to the previous month in terms of the total invalidated points at the time of inquiry (at a step S1106). This ratio data is a ratio of the total invalidated points at the time of receiving the inquiry to those in the previous month and the ratio is 1.09 in the example of FIG. 12.

Finally, the point information output unit 134d transmits information on the total invalidated points at the time of receiving the inquiry, the points predicted to be paid back to the customer, and the ratio of points at the time of receiving the inquiry to those in the previous month to the customer terminal 11a or 11b, thereby notifying the customer of the information (at a step S1107). At the time of transmission of the information, the point information output unit 134d also transmits an advertisement for sales promotion of the dealer to the customer terminal 11a or 11b.

As explained above, in the first embodiment, the invalidated points of each customer are accumulated for each period defined by the payback date and stored as the total invalidated points. The total invalidated points are distributed to the respective customers according to their purchasing results such as the frequencies of purchasing and the points distributed to the respective customers are paid back. Therefore, by making payback the points that have been conventionally invalidated in vain to each customer and motivating the customer' purchasing desire, it is possible to more effectively perform sales promotions of products.

The point management apparatus and the point management method explained in the first embodiment can be realized by allowing a computer system such as a personal computer or a workstation to execute a program prepared in advance. In a second embodiment of the present invention, therefore, the computer system which executes a point management program equivalent in function to the point management apparatus and the point management method explained in the first embodiment will be explained.

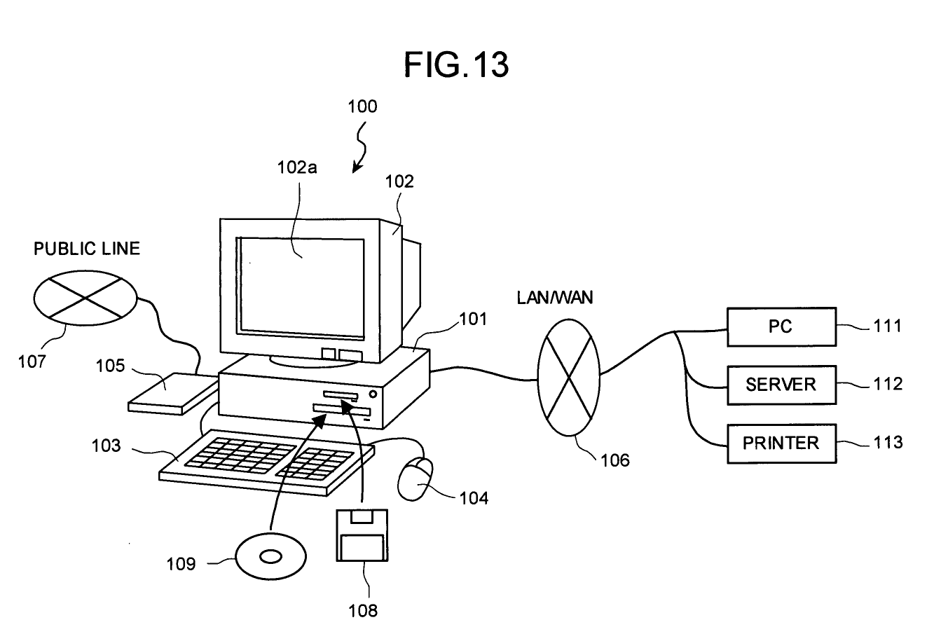

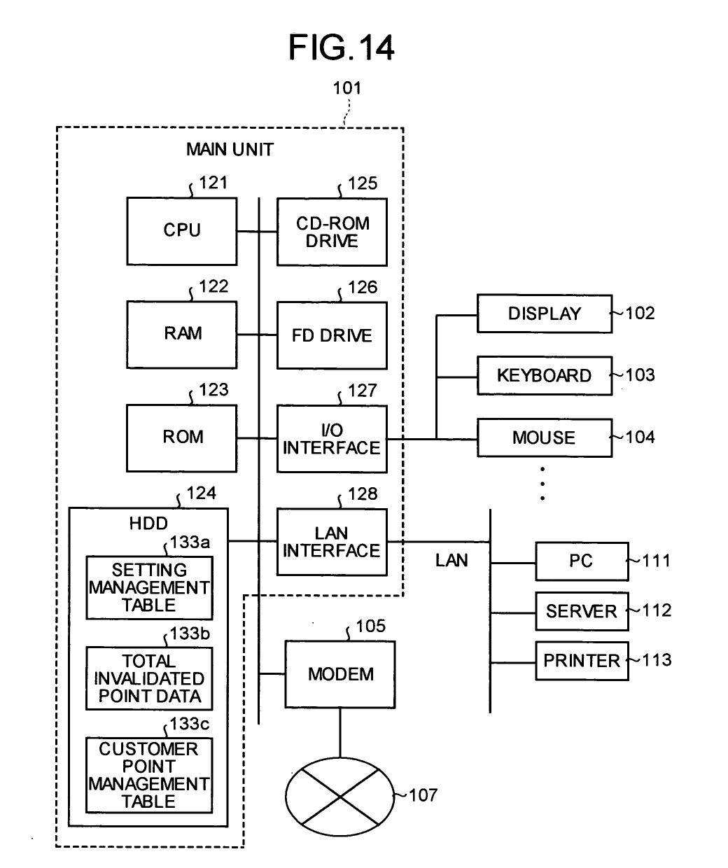

FIG. 13 is a schematic diagram of a computer system according to the second embodiment. FIG. 14 is a block diagram of a main unit of the computer system shown in FIG. 13. The computer system 100 in the second embodiment includes a display 102 for displaying information such as an image on a display screen 102a in accordance with an instruction from the main unit 101, a keyboard 103 for inputting various pieces of information to this computer system 100, and a mouse 104 for designating an arbitrary position on the display screen 102a of the display 102.

The main unit 101 of the computer 100 includes a central processing unit (CPU) 121, a random access memory (RAM) 122, a read only memory (ROM) 123, a hard disk drive (HDD) 124, a CD-ROM drive 125 which receives the CD-ROM 109, an flexible disk (FD) drive 126 that receives an FD 108, an I/O interface 127 that connects the display 102, the keyboard 103, and the mouse 104 to one another, and a local area network (LAN) interface 128 that connects to a local area network/a wide area network (LAN/WAN) 106. The HDD 124 stores the setting management table 133a, the total invalidated point data 133b, and the customer point management table 133c shown in FIG. 1.

Further, to this computer system 100, a modem 105 for connecting the computer system 100 to a public line 107 such as the Internet is connected. In addition, other computer system (PC) 111, a server 112, a printer 113, and the like are connected thereto through the LAN interface 128 and the LAN/WAN 106.

This computer system 100 realizes the point management apparatus and the point management method by reading and executing the point management program recorded on a predetermined recording medium. Examples of the predetermined recording medium include all types of recording mediums that record the point management program readable by the computer system 100. Namely, they include “portable physical mediums” such as the FD 108, the CD-ROM 109, a magneto-optical (MO) disk, a DVD disk, and an IC card, “fixed physical mediums” such as the HDD 124, the RAM 122, and the ROM 123 installed inside or outside of the computer system 100, and “communication mediums” for holding the program for a short period of time when transmitting the program, such as the public line 107 connected to the computer system 100 through the modem 105 and the LAN/WAN 106 through which the other computer system 111 and the server 112 are connected to the computer system 100.

That is, the point management program is recorded in a computer readable fashion on the recording medium such as “the portable physical medium”, “the fixed physical medium” or “the communication medium”. The computer system 100 reads and executes the point management program from such a recording medium, thereby realizing the point management apparatus and the point management method. The point management program is not limited to the program executed by the computer system 100. The present invention is similarly applicable to an instance in which the other computer system 111 or the server 112 executes the point management program or an instance in which a combination of the other computer system 111 and the server 112 execute the point management program.

While exemplary embodiments of the present invention are explained so far, various modifications of the embodiments may be practiced within a technical regime described through the whole documents.

In the embodiments of the present invention, the latest purchasing date of each customer and the points allotted to the customer are stored in the customer point management table 133c. However, the present invention is not limited to the embodiments. Alternatively, points may be discriminated according to purchasing and the points that each customer accrues in each purchasing may be stored in the customer point management table 133c.

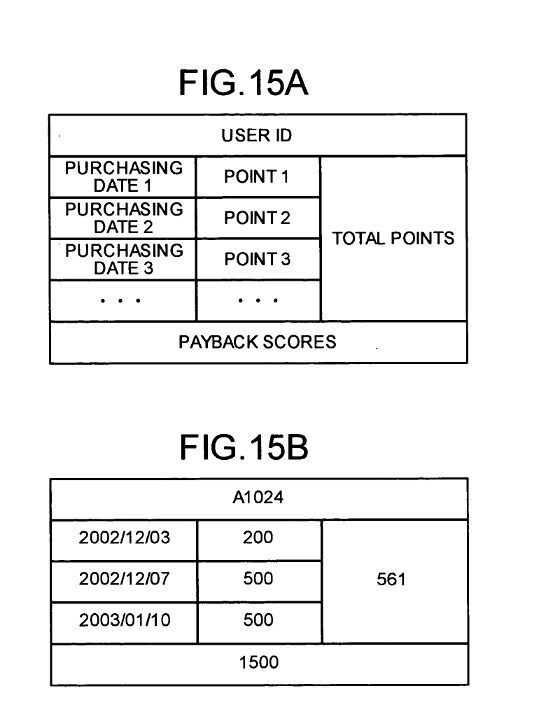

FIGS. 15A and 15B depict an example of managing points with a purchasing basis in the customer point management table 133c shown in FIG. 6. In this example, the customer point management table 133c includes items of purchasing dates, points allotted to each customer in each purchasing, and payback scores. FIG. 15B depicts an example of the customer point management table 133c that actually stores data.

This example differs from the first embodiment only in that points to be invalidated in each purchasing are calculated for the points allotted in the respective purchasing (points 1, points 2, points 3, . . . ) based on the setting of the point invalidation setting table shown in FIG. 2. Namely, in FIG. 15B, among 200 points allotted on Dec. 3, 2002, 20%, i.e., 40 points (200 points×0.2=40 points) are invalidated on Dec. 24, 2002, three weeks after Dec. 3, 2002. Among 500 points allotted on Dec. 7, 2002, 20%, i.e., 100 points (500 points×0.2=100 points) are invalidated on Dec. 28, 2002, three weeks after Dec. 7, 2002. Other processings can be performed similarly to those in the first embodiment.

According to the embodiments of the present invention, the points to be paid back to each customer are calculated according to the payback scores of the customer. However, the present invention is not limited to the embodiments and the points may be distributed to customers who draw winning numbers of a ballot at predetermined ratios, respectively. Alternatively, the calculation-basis method and the drawing-basis method may be switched over for every payback date according to the payback scores. Further, the points to be paid back may be calculated by other methods.

According to the embodiments of the present invention, if the customer does no purchasing within the predetermined period, the points of the customers are invalidated by the predetermined ratio. However, the present invention is not limited to the embodiments. If a purchasing amount within the predetermined period does not reach a predetermined amount, the points of the customer may be invalidated by a predetermined ratio. In this case, the ratio of invalidating points may be changed according to the purchasing amount within the predetermined period. Alternatively, the points may be invalidated by other method.

According to the embodiments of the present invention, the payback scores are calculated according to the period passing since the latest purchasing date until the next purchasing date and allotted to each customer. However, the present invention is not limited to the embodiments and the payback scores may be calculated according to the purchasing amount within the predetermined period and allotted to the customer. Further, the payback scores may be calculated based on both the period passing since the latest purchasing date and the purchasing amount. Fixed payback scores may be allotted to each customer per purchasing. The payback scores may be calculated by other methods and allotted to each customer.

According to the embodiments of the present invention, the points are calculated according to the period passing since the latest purchasing date until the next purchasing date and allotted to each customer. However, the present invention is not limited to the embodiments and the points may be calculated according to the purchasing amount within the predetermined period and allotted to each customer. Further, the dealers of products may offer a certain ratio of points to each customer besides the invalidated points so as to perform sales promotions of the dealer. Further, the points may be calculated by other methods and allotted to each customer.

According to the embodiments of the present invention, the point management apparatus 13 calculates the points and payback scores allotted to each customer. However, the present invention is not limited to the embodiments and the dealer terminals 10a and 10b may calculate them. In this case, whenever calculating the points and payback scores allotted to each customer, each of the dealer terminals 10a and 10b transmits information thereon to the point management apparatus 13. The point management apparatus 13 updates the corresponding data in the customer point management table 133c.

Among the respective processings explained in the embodiments of the present invention, all of or part of those explained to be performed automatically can be performed manually and all of or part of those explained to be performed manually can be performed automatically. Further, the processing procedures, control procedures, concrete names, and information including various pieces of data and parameters explained in the specification or shown in the drawings can be arbitrarily changed unless specified otherwise.

The respective constituent elements of the respective units of the apparatus shown in the drawings are functionally conceptual and are not necessarily constituted physically as shown in the drawings. Namely, the concrete manners of distribution or integration of the units of the apparatus are not limited to those shown in the drawings but all of or part of the units can be functionally or physically distributed or integrated in arbitrary units according to various loads and utilization states of the units. In addition, all of or part of the respective processing functions performed by the units of the apparatus can be realized by a CPU and a program analyzed and executed by the CPU or realized as a wired logic hardware.

As explained so far, according to one aspect of the present invention, even if the points are invalidated, it is advantageously possible to stimulate the customers' purchasing desire and effectively perform sales promotions of products by making payback the invalidated points to each customer.

According to another aspect of the present invention, it is advantageously possible to distribute more points to the customer having more purchasing results and further effectively perform sales promotions of products.

According to still another aspect of the present invention, it is advantageously possible to effectively distribute more points to the customer having more purchasing results and stimulate the customers' purchasing desire to thereby further effectively perform sales promotions of products.

According to still another aspect of the present invention, by invalidating fewer points from the customer having more purchasing results, it is advantageously possible to promote the customer to be fixed to the dealer and further perform sales promotions of products.

According to still another aspect of the present invention, by invalidating more points of the customer having fewer purchasing results, it is advantageously possible to promote the customer having the fewer purchasing results to actively purchase products at the dealer and further effectively perform sales promotions of products.

According to still another aspect of the present invention, the customer can check an accumulation status of the total invalidated points and the customer actively purchases products so that more points can be distributed to the customer.

According to still another aspect of the present invention, the customer can check the prediction result of the points to be paid back and the customer actively purchases products so that more points can be distributed to the customer if the predicted points to be paid back are fewer.

According to still another aspect of the present invention, the customer can predict the total invalidated points used to calculate the points to be paid back to the customer and the customer actively purchases products so that more points can be distributed to the customer if the predicted total invalidated points are more.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for managing a point allotted to each customer for an amount of a purchasing and for invalidating the point that is not used within a predetermined period, the apparatus comprising:
an invalidated point calculating unit that calculates total invalidated points from a sum of the points invalidated for all customers; and
a point payback calculating unit that calculates a point payback to be distributed to each customer from the total invalidated points, and that makes a payback of the point calculated to the each customer.

2. The apparatus according to claim 1, further comprising:
a history storing unit that stores a purchasing history of the each customer, wherein
the point payback calculating unit calculates an amount of the points to be paid back to the each customer based on the purchasing history.

3. The apparatus according to claim 2, wherein
the purchasing history includes a purchasing date of a product, and
the point payback calculating unit calculates the amount of the points to be paid back to the each customer by scoring the each customer according to number of days passed since the purchasing date to a next purchasing date and multiplying the total invalidated points by a ratio of a score of the each customer to a sum of scores of all customers.

4. The apparatus according to claim 2, further comprising:
a point invalidating unit that invalidates points of a customer that are not used for a predetermined period based on the purchasing history, wherein
the invalidated point calculating unit calculates a sum of the points of all customers invalidated by the point invalidating unit as the total invalidated points.

5. The apparatus according to claim 4, wherein the point invalidating unit invalidates the points that are not used for the predetermined period if the customer makes no purchasing within the predetermined period.

6. The apparatus according to claim 1, further comprising:
an information output unit that outputs at least information on an accumulation status of the total invalidated points calculated by the invalidated point calculating unit.

7. The apparatus according to claim 6, further comprising:
an estimating unit that estimates the points to be paid back to the each customer based on the information on the accumulation status of the total invalidated points, wherein
the information output unit further outputs information on the points to be paid back to the each customer estimated.

8. The apparatus according to claim 6, further comprising:
a transition calculating unit that calculates a transition of the total invalidated points for a preset period, wherein
the information output unit further outputs information on the transition of the total invalidated points.

9. A method of managing a point allotted to each customer for an amount of a purchasing and for invalidating the point that is not used within a predetermined period, the method comprising:
calculating total invalidated points from a sum of the points invalidated for all customers;
calculating a point payback to be distributed to each customer from the total invalidated points; and
making a payback of the point calculated to the each customer.

10. The method according to claim 9, further comprising:
storing a purchasing history of the each customer, wherein
an amount of the points to be paid back to the each customer is calculated based on the purchasing history.

11. The method according to claim 10, wherein
the purchasing history includes a purchasing date of a product, and
the amount of the points to be paid back to the each customer is calculated by scoring the each customer according to number of days passed since the purchasing date to a next purchasing date and multiplying the total invalidated points by a ratio of a score of the each customer to a sum of scores of all customers.

12. The method according to claim 10, further comprising:
invalidating points of a customer that are not used for a predetermined period based on the purchasing history, wherein
at the calculating the total invalidated points, a sum of the points of all customers invalidated at the invalidating is calculated as the total invalidated points.

13. The method according to claim 12, wherein at the invalidating, the points that are not used for the predetermined period are invalidated if the customer makes no purchasing within the predetermined period.

14. The method according to claim 9, further comprising:
outputting point information that outputs at least information on an accumulation status of the total invalidated points calculated.

15. The method according to claim 14, further comprising:
estimating the points to be paid back to the each customer based on the information on the accumulation status of the total invalidated points, wherein
the outputting further outputs information on the points to be paid back to the each customer estimated.

16. The method according to claim 14, further comprising:
calculating a transition of the total invalidated points for a preset period, wherein
the outputting further outputs information on the transition of the total invalidated points.

17. A computer program for managing a point allotted to each customer for an amount of a purchasing and for invalidating the point that is not used within a predetermined period, the computer program making a computer execute:
calculating total invalidated points from a sum of the points invalidated for all customers;
calculating a point payback to be distributed to each customer from the total invalidated points; and
making a payback of the point calculated to the each customer.
